(19) United States
(12) Patent Application Publication
(10) Pub. No.: US 2013/0132247 A1
(43) Pub. Date: May 23, 2013

(54) MANAGEMENT APPARATUS, MANAGEMENT METHOD, AND RECORDING MEDIUM OF MANAGEMENT PROGRAM

(71) Applicant: Fujitsu Limited, Kawasaki (JP)

(72) Inventor: Kenichirou SHIMOGAWA, Numazu (JP)

(73) Assignee: FUJITSU LIMITED, Kawasaki (JP)

(21) Appl. No.: 13/680,780

(22) Filed: Nov. 19, 2012

(30) Foreign Application Priority Data
Nov. 21, 2011 (JP) 2011-254468

(51) Int. Cl. G06Q 30/04

(52) U.S. Cl. CPC G06Q 30/04
USPC 705/34

(57) ABSTRACT

A management method for billing system, the management method includes setting, by a processor, billing address for usage fees of a virtual machine, deployed based on a deploy instruction from a first account, to a second account from which execution instruction for software, which runs on the virtual machine, is issued.

### CROSS-REFERENCE TO RELATED APPLICATION

This application is based upon and claims the benefit of priority of the prior Japanese Patent Application No. 2011-254468, filed on Nov. 21, 2011, the entire contents of which are incorporated herein by reference.

### FIELD

The embodiments discussed herein are related to management of usage of software.

### BACKGROUND

Systems that provide software to user terminals have been developed. For example, a system that provides software to a user terminal transmits software that the user can use for 60-day trial period via a network. Upon receipt of the software, the user terminal downloads the software thereinto. In this way, the user can execute the software by operating the terminal and evaluate the software to determine if the software meets business and usability requirements of the user during the trial period.

If the software meets the user's requirements, the user pays a license fee to obtain a license key for continued use of the software during or after the trial period.

Upon receipt of the license key input by the user via the user terminal, the system that provided the software to the user's terminal enables the user to continuously use the software. Note that if the user does not inform the system of an instruction indicating that the user continuously use the software (e.g., if the user does not input the license key), execution of the software on the user terminal is disabled after the trial period has expired.

Examples of the system that provided the software to a user terminal include a system that transmits information regarding the expiration date of software from a management server to the user terminal. In such a system, upon receipt of the information regarding the expiration date of software, the terminal stores the received information in a storage unit. If the current date exceeds the stored expiration date, the system performs control so that the software does not start.

However, in such an existing system, a method for continuously using the software is not user friendly. That is, for example, in order to continuously use a service (software) in the above-described existing system, the user inputs the license key. This operation is troublesome for the user. A license key is provided for each of a large number of software items that the user can use. Thus, the user is forced to manage an enormous number of license keys. This is also troublesome for the user.

In addition, in the above-described systems that transmit information regarding the expiration date of the software to a user terminal, if the terminal has settings so that a storage unit is not allowed to store any information received from an external apparatus, the received expiration date information is not stored in the storage unit. In such a case, it is difficult for the terminal to manage the expiration date of software.

### SUMMARY

According to an aspect of the invention, a management method includes setting, by a processor, billing address for usage fees of a virtual machine, deployed based on a deploy instruction from a first account, to a second account from which execution instruction for software, which runs on the virtual machine, is issued.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the configuration of a system including the management apparatus according to the exemplary embodiment.

FIG. 2 illustrates an example of the functional configuration of the management apparatus according to the exemplary embodiment.

FIG. 3 illustrates an example of the data structure of a DB.

FIG. 4 is a sequence diagram illustrating an example of the sequence of the processes performed by the system according to the exemplary embodiment.

FIG. 5 is a sequence diagram illustrating an example of the sequence of the processes performed by the system according to the exemplary embodiment.

FIG. 6 is a sequence diagram illustrating an example of the sequence of the processes performed by the system according to the exemplary embodiment.

FIG. 7 is a flowchart of an example of the procedure of a first management process according to the exemplary embodiment.

FIG. 8 is a flowchart of an example of the procedure of a second management process according to the exemplary embodiment.

FIG. 9 is a flowchart of an example of the procedure of a third management process according to the exemplary embodiment.

FIG. 10 is a sequence diagram illustrating an example of the sequence of the processes performed by a system according to a modification.

FIG. 11 is a flowchart of an example of the procedure of a second management process according to the modification.

FIG. 12 illustrates a computer that executes a management program.

### DESCRIPTION OF EMBODIMENTS

A management apparatus, a management program, and a management method according to exemplary embodiments of the present disclosure are described in detail below with reference to the accompanying drawings. It is to be noted that the embodiments are not intended to limit the disclosure to the particular forms and examples disclosed. In addition, the embodiments can be appropriately combined if no conflict occurs.

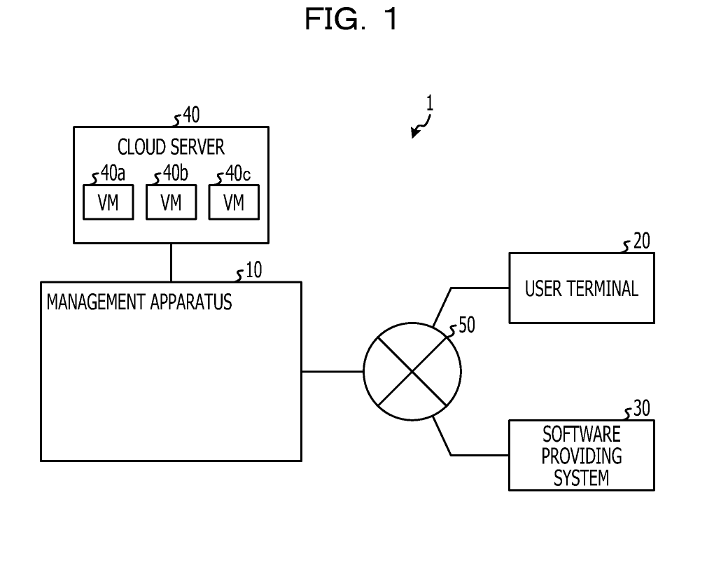

A management apparatus according to the exemplary embodiments is described below. FIG. 1 illustrates an example of the configuration of a system including the management apparatus according to the exemplary embodiments. As illustrated in FIG. 1, a system 1 includes a management apparatus 10, a user terminal 20, a software providing system 30, and a cloud server 40. The management apparatus 10, the user terminal 20, and the software providing system 30 can communicate with one another via a network 50. In addition, the management apparatus 10 is connected to the cloud server 40 so as to communicate with the cloud server 40. For example, the management apparatus 10 and the cloud server 40 are placed in an ICT system of a cloud service provider.

In the example illustrated in FIG. 1, the management apparatus 10 creates a virtual machine (VM) 40a in the cloud server 40 in response to an instruction received from the software providing system 30. Thereafter, in the example illustrated in FIG. 1, the management apparatus 10 instructs the VM 40a to download software provided by the software providing system 30. Thus, the VM 40a can execute the software. In the example illustrated in FIG. 1, upon receipt of a request for executing the software from the user terminal 20, the management apparatus 10 instructs the VM 40a to execute the software if the user operating the user terminal 20 has authorization to execute the software. Subsequently, the management apparatus 10 transmits the result of processing performed by the VM 40a to the user terminal 20. In this way, the management apparatus 10 allows the user to execute the software in the VM 40a. Similarly, the management apparatus 10 instructs the cloud server 40 to create VMs 40b and 40c in response to an instruction received from the software providing system 30. Thereafter, the management apparatus 10 allows different user terminals (not illustrated) connected to the network 50 to receive the results of processing performed in the VMs 40b and 40c. That is, the management apparatus 10 allow the users operating the different user terminals to execute the software on the VMs 40b and 40c. Note that the number of the management apparatuses 10, the number of the user terminals 20, the number of the software providing systems 30, and the number of the cloud servers 40 in the system 1 can be set to any number. In addition, the number of VMs created in the cloud server 40 may be set to any number.

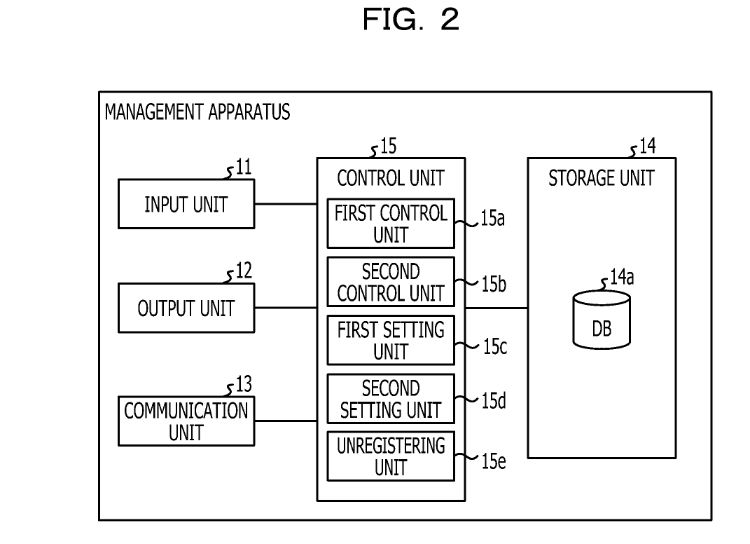

FIG. 2 illustrates the functional configuration of the management apparatus according to the present exemplary embodiment. As illustrated in FIG. 2, the management apparatus 10 includes an input unit 11, an output unit 12, a communication unit 13, and a storage unit 14, and a control unit 15.

The input unit 11 inputs a variety of information items to the control unit 15. For example, the input unit 11 receives, from a user, an instruction to acquire the operating conditions of the cloud server 40 and inputs the received instruction to the control unit 15. Examples of the input unit 11 include devices that receive a user operation, such as a mouse and a keyboard.

The output unit 12 displays a variety of information items. For example, the output unit 12 displays the operating conditions of the cloud server 40 under the control of a second control unit 15b (described in more detail below). An example of the output unit 12 is a liquid crystal display.

The communication unit 13 functions as an interface for communicating with a variety of units. For example, the communication unit 13 is connected to the cloud server 40. In addition, the communication unit 13 is connected to the user terminal 20 and the software providing system 30 via the Internet 50. In this way, the management apparatus 10, the cloud server 40, the user terminal 20, and the software providing system 30 can communicate with one another.

The storage unit 14 stores a variety of information items. For example, the storage unit 14 stores a database (DB) 14a.

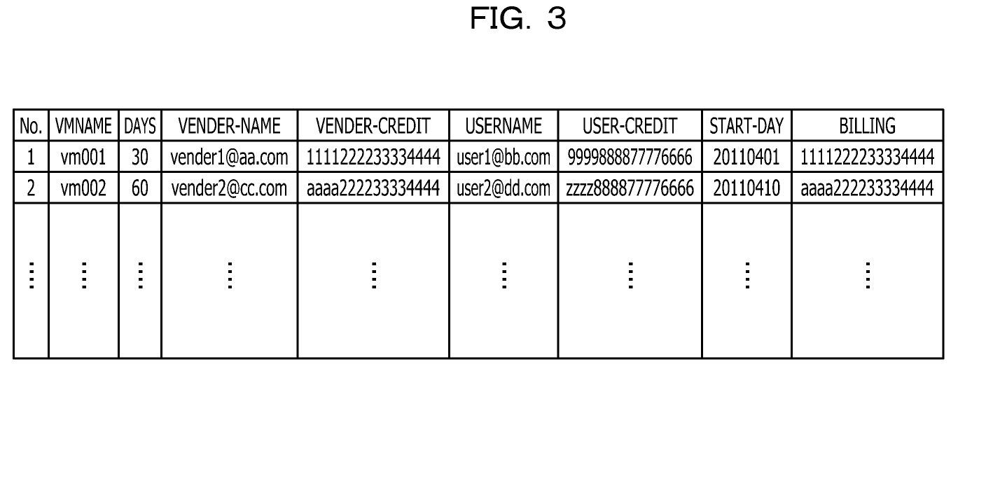

The DB 14a contains information regarding software that the user terminal 20 can execute. FIG. 3 illustrates an example of the data structure of the DB. In the example illustrated in FIG. 3, a record of the DB 14a includes the following fields: “No.”, “vmname”, “days”, “vender-name”, and “vender-credit”. In the example illustrated in FIG. 3, the DB 14a further includes the following fields: “username”, “user-credit”, “start-day”, and “billing”. Data items corresponding to these fields are set in the fields by the second control unit 15b as described below.

The “No.” field contains a record number. In the example illustrated in FIG. 3, the number “1” is set in the “No.” field of a first record.

The “vmname” field contains the identifier of a VM that is usable by the user terminal 20 of the user. In the example illustrated in FIG. 3, the identifier “vm001” that is usable by the user is contained in the “vmname” field of the first record.

The “days” field contains the period of time during which software executed by the VM is available. Examples of such a period include a trial period of the software during which the software can be used with no fee or low fee and a license period that starts when the user pays a license fee after the trial period has expired. In the following description, a trial period is contained in the “days” field. In the example illustrated in FIG. 3, the “days” field of the first record contains “30” days.

The “vender-name” field contains the mail address of a server of the software providing system that provided the software executed by the VM. In the example illustrated in FIG. 3, the “vender-name” field of the first record contains the mail address “vender@aa.com” of the server of the software providing system that provided the software.

The “vender-credit” field contains the credit card number of a software vendor that owns a software providing system. In the example illustrated in FIG. 3, the “vender-credit” field of the first record contains the credit card number “1111222233334444” of the software vendor.

The “username” field contains the mail address of the user terminal 20 of the user. In the example illustrated in FIG. 3, the “username” field of the first record contains the mail address “user1@bb.com” of the user terminal 20.

The “user-credit” field contains the credit card number of the user. In the example illustrated in FIG. 3, the “user-credit” field of the first record contains the credit card number “9999888877776666” of the user.

The “start-day” field contains the first day of the license period of the software. In the example illustrated in FIG. 3, the “start-day” field of the first record contains the first day “20110401” (i.e., Apr. 1, 2011) of the license period of the software.

The “billing” field contains a billing address for the license of the VM. In the example illustrated in FIG. 3, the “billing” field of the first record contains the credit card number “1111222233334444” of the vendor that provides the software.

For example, the DB 14a is used to determine whether the user of the software has authorization to execute the software on the VM. In addition, the DB 14a is used to refer to the billing address of the VM.

For example, a semiconductor memory device (e.g., a flash memory), a hard disk, or an optical disk is used as the storage unit 14. Note that the storage unit 14 is not limited to one of the above-described types of storage unit. For example, a random access memory (RAM) or a read only memory (ROM) may be used as the storage unit 14.

The control unit 15 includes an internal memory that stores a program defining a variety of processing procedures and control data. The control unit 15 performs a variety of processes using such programs and data. As illustrated in FIG. 2, the control unit 15 further includes a first control unit 15a, the second control unit 15b, a first setting unit 15c, a second setting unit 15d, and an unregistering unit 15e.

Upon receipt of an instruction to create a VM from the software providing system 30, the first control unit 15a sends an instruction to create a VM to the cloud server 40. Thus, a VM is created in the cloud server 40. That is, upon receipt of such an instruction, the first control unit 15a performs control so that a VM is created.

In addition, upon receipt of software from the software providing system 30, the first control unit 15a sends the software to the VM running on the cloud server 40 so that the VM downloads the software. That is, upon receipt of the software, the first control unit 15a performs control so that the VM can execute the software.

The operation is described in more detail below. Upon receipt of a virtual machine creation instruction to create the VM 40a from the software providing system 30, the first control unit 15a generates the identifier of the VM 40a and sends a virtual machine creation instruction including the generated identifier to the cloud server 40. Thereafter, the cloud server 40 creates the VM 40a corresponding to the identifier included in the virtual machine creation instruction. Note that as described below, the virtual machine creation instruction sent from the software providing system 30 to the management apparatus 10 includes the mail address of the user terminal 20 and the mail address of the server of the software providing system. Accordingly, the management apparatus 10 can communicate with the user terminal 20 and the software providing system 30 by using these mail addresses. After that point in time, in order to transmit a variety of information items to the user terminal 20 and the software providing system 30, the management apparatus 10 uses the above-described mail addresses.

Upon receipt of a completion notification indicating that creation of the VM 40a is completed from the cloud server 40, the first control unit 15a sends the received completion notification to the software providing system 30. Note that as described in more detail below, the completion notification includes the identifier of the created VM 40a. In addition, upon receipt of, from the software providing system 30, the identifier of the VM 40a, the license period of the software, and the software having the credit card number of the software vendor attached thereto, the first control unit 15a performs the following processing. That is, the first control unit 15a transmits the received software to the VM 40a identified by the identifier attached to the software so that the VM 40a downloads the software. In this manner, the VM 40a can download the software and execute the software.

The second control unit 15b performs control so that the software is executed by the VM in response to a software execution instruction sent from the user terminal and, thereafter, the result of the processing performed by the software is sent to the user terminal.

This operation is described in more detail below. Upon receipt of the identifier of the VM 40a that is to execute the software and an execution instruction of the software having the mail address of the user terminal 20 attached thereto from the user terminal 20, the second control unit 15b performs the following processing. That is, the second control unit 15b searches the DB 14a for a record having the “vmname” field containing the identifier of the VM 40a included in the execution request and the “username” field containing the mail address included in the execution request. In this way, the second control unit 15b determines whether the user of the user terminal 20 which the second control unit 15b can communicate with using the mail address contained in the “username” field has authorization to use the software.

If a matched record is found, the second control unit 15b sends a software execution request to the VM 40a indicated by the attached identifier. In addition, the second control unit 15b sends, to the user terminal 20, the result of processing performed by the software, that is, the result sent from the VM 40a.

However, if a matched record is not found, the second control unit 15b sends, to the user terminal 20, an error message indicating that the software and the VM 40a are not available.

In addition, upon receipt of, from the input unit 11, an instruction to acquire the operating conditions of the cloud server 40, the second control unit 15b acquires the operating conditions of the cloud server 40 from the cloud server 40 and controls the output unit 12 so that the output unit 12 displays the acquired operating conditions. Furthermore, the second control unit 15b acquires, from the cloud server 40, the operating conditions of the VM running in the cloud server 40 and sends the acquired operating conditions to the software providing system 30.

If the VM is created, the first setting unit 15c sets the billing address related to the license of the VM to the billing address corresponding to the software providing system.

This operation is described in more detail below. The first setting unit 15c generates virtual machine related information. The virtual machine related information includes the identifier of the newly created VM 40a and the following information items associated with the identifier: the license period of the received software, the mail address of the server of the software providing system 30, the credit card number of the software vendor, and the mail address of the user terminal 20. Note that the virtual machine related information may further include the credit card number of the user and the billing address for the license of the VM 40a.

Subsequently, the first setting unit 15c sends the generated virtual machine related information to the user terminal 20. Thereafter, the first setting unit 15c generates a record containing the generated virtual machine related information in the DB 14a. At that time, the first setting unit 15c sets the information items included in the virtual machine related information in the corresponding fields of the generated record. In addition, the first setting unit 15c registers the credit card number of the software vendor in the “billing” field.

Subsequently, the first setting unit 15c sends a license start notification indicating that the license period of the software is started to the software providing system 30. Thereafter, the first setting unit 15c registers the current date in the “start-day” field of the generated record as the license start date on which the license period of the software starts.

Subsequently, the first setting unit 15c refers to the DB 14a and starts a billing process in which payment for the usage of the VM 40a is charged on the billing address registered in the “billing” field. At that time, as described in more detail below, if the user terminal 20 requests trial of the software, the software providing system 30 sends a virtual machine creation instruction to the management apparatus 10. Therefore, the billing address for the usage of the VM 40a during the trial period of the software is set to the credit card number of the software vendor.

The second setting unit 15d replaces the billing address for the use of the VM from the credit card number of the software vendor to the credit card number of the user of the user terminal.

This operation is described in more detail below. The second setting unit 15d performs the following process at predetermined time intervals. That is, the second setting unit 15d refers to the DB 14a and adds a license period registered in the “days” field to the date registered in the “start-day” field for all of the records. The date computed in this manner indicates an example of the expiration date of the trial period of the software. Thereafter, the second setting unit 15d determines whether the number of days between the current date and the expiration date of the trial period is no more than a predetermined number of days (e.g., 10 days) for each of all of the records. If the number of days between the current date and the expiration date of the trial period is no more than the predetermined number of days, the second setting unit 15d sends a message indicating that the expiration date is coming soon to the user of the user terminal for which the number of days between the current date and the expiration date of the trial period is no more than the predetermined number of days. In this way, the user of the user terminal can be prompted to make a license agreement for permanent use instead of the license agreement for the trial period. In addition, if the number of days between the current date and the expiration date of the trial period is no more than the predetermined number of days, the second setting unit 15d sends a message indicating that the expiration date is coming soon to the software providing system 30. In this way, the second setting unit 15d can cause the software providing system 30 to prompt the user to make a license agreement for permanent use instead of the license agreement for the trial period. The second setting unit 15d performs such a process at predetermined time intervals.

In addition, each time the second setting unit 15d receives a message from the user terminal 20, the second setting unit 15d performs the following processing. That is, the second setting unit 15d determines whether the received message indicates that the user continues to use the software. If the received message indicates that the user continues to use the software, the second setting unit 15d sends a message indicating that the user continues to use the software to the software providing system 30. If the second setting unit 15d receives, from the software providing system 30, a virtual machine transferal message indicating transfer of the VM, the second setting unit 15d searches the DB 14a for a record containing the identifier that matches the identifier included in the virtual machine transferal message. Thereafter, the second setting unit 15d sets the credit card number of the user included in the virtual machine transferal message in the “billing” field of a record found through the search operation. That is, the second setting unit 15d changes the billing address from the credit card number of the software vendor to the credit card number of the user. The second setting unit 15d performs the above-described process each time the second setting unit 15d receives a message from the user terminal 20.

Furthermore, the unregistering unit 15e performs the following process each time the unregistering unit 15e receives a message from the user terminal 20. That is, the unregistering unit 15e determines whether the received message indicates that the user terminates the license of the software. If the received message indicates that the user terminates the license of the software, the unregistering unit 15e sends, to the cloud server 40, an instruction indicating that the VM indicated by the identifier included in the message indicating that the user terminates the license of the software is to be deleted. Thus, the cloud server 40 deletes the corresponding VM. Subsequently, the unregistering unit 15e stops charging the fee for the use of the VM. Thereafter, the unregistering unit 15e sends, to the software providing system 30, a delete message indicating that a VM has been deleted and including the identifier of the deleted VM. Thus, the software providing system 30 stops charging a fee for the use of the software executed on the deleted VM. Subsequently, the unregistering unit 15e searches the DB 14a for a record having the “vmname” field containing the identifier of the deleted VM and deletes the found record. That is, the unregistering unit 15e deletes the virtual machine related information regarding the deleted VM.

In addition, the unregistering unit 15e performs the following process at predetermined time intervals. That is, the unregistering unit 15e refers to the DB 14a and computes a date by adding a license period registered in the “days” field to the date registered in the “start-day” field for each of all of the records. The computed date is an example of the expiration date of the trial period of the software. Thereafter, the unregistering unit 15e determines whether the current date exceeds the expiration date of the trial period. If the current date exceeds the expiration date, the unregistering unit 15e sends, to the cloud server 40, an instruction to delete the VM indicated by the identifier registered in the “vmname” field of the record having an expiration date that has already expired. Subsequently, the unregistering unit 15e stops charging a fee for the use of the VM. Thereafter, the unregistering unit 15e sends, to the software providing system 30, a virtual machine delete message indicating that a VM has been deleted and including the identifier of the deleted VM. Subsequently, the unregistering unit 15e searches the DB 14a for a record having the “vmname” field containing the identifier of the deleted VM and deletes the found record. That is, the unregistering unit 15e deletes the virtual machine related information regarding the deleted VM.

The user terminal 20 is operated by the user. Through the operation performed by the user, the user terminal 20 can apply for trial of the software to the software providing system 30. When applying the trial, the user terminal 20 sends the mail address of the user terminal 20 and the name of the trial software to the software providing system 30. In addition, the user terminal 20 receives the virtual machine related information from the management apparatus 10 and stores the received virtual machine related information in the storage unit.

In addition, the user terminal 20 sends, to the management apparatus 10, the identifier of the VM 40a that executes the software and the execution request of the software having the mail address of the user terminal 20 attached thereto. Upon receipt of the result of processing performed by the software from the management apparatus 10, the user terminal 20 displays the received result of processing on the display unit of the user terminal 20. Furthermore, upon receipt of an error message from the management apparatus 10, the user terminal 20 displays the received error message on the display unit of the user terminal 20.

Still furthermore, triggered by a user operation, the user terminal 20 sends, to the management apparatus 10, the name of the software that the user wants to continue using after the trial period has expired, the identifier of the VM that executes the software, and a notification indicating that the software is continuously used and including the credit card number of the user. Alternatively, triggered by a user operation, the user terminal 20 sends, to the management apparatus 10, the name of the software that the user wants to stop using after the trial period has expired and a notification indicating that the use of the software is stopped and including the identifier of the VM that executes the software.

The software providing system 30 includes a server that provides software. The owner of the software providing system 30 is a software vendor of the software. Upon receipt of an application for trial of the software from the user terminal 20, the software providing system 30 sends, to the management apparatus 10, a virtual machine creation instruction including the mail address of the user terminal 20 and the mail address of the server that provides the software.

In addition, upon receipt of the completion notification from the management apparatus 10, the software providing system 30 performs the following process. That is, the software providing system 30 sends, to the management apparatus 10, the identifier of the VM included in the completion notification, the license period of the software, and the software having the credit card number of the software vendor attached thereto. Furthermore, the software providing system 30 stores the identifier of the VM, the name of the software executed by the VM, the mail address of the user terminal 20, and the license period of the software in the storage unit of the software providing system 30. Upon receipt of a license start notification from the management apparatus 10, the software providing system 30 stores the current date in the storage unit as a license start date indicating the date at which the use of the software starts.

Still furthermore, upon receipt of a message indicating that the software will soon reach its expiration date, the software providing system 30 sends a message prompting the user to make a license agreement for permanent use to the user terminal 20.

Still furthermore, upon receipt of a message indicating that the use of the software is continued, the software providing system 30 withdraws the fee of the software license from a credit card account using the user's credit card number included in the message. Subsequently, the software providing system 30 obtains the identifier of a VM included in the received message and sends a virtual machine transferal message including the obtained identifier of a VM to the management apparatus 10.

Yet still furthermore, upon receipt of, from the management apparatus 10, a virtual machine delete notification indicating that a VM is deleted, the software providing system 30 stops billing of future payment for the license of the software executed on the VM indicated by the identifier included in the notification.

The cloud server 40 creates a VM on the basis of the virtual machine creation instruction sent from the management apparatus 10. After creation of the VM is completed, the cloud server 40 sends a completion notification including the identifier of the created VM to the management apparatus 10.

Upon receipt of the software from the management apparatus 10, the VM created by the cloud server 40 downloads the received software. In this way, the VM can execute the software.

In addition, upon receipt of an execution request of the software from the management apparatus 10, the cloud server 40 instructs the VM indicated by the identifier included in the received execution request to execute the software. Thereafter, the cloud server 40 sends, to the management apparatus 10, the result of processing performed by the software on the VM.

Furthermore, upon receipt of an instruction to delete a VM, the cloud server 40 deletes the VM indicated by the identifier included in the received instruction.

The control unit 15 is formed from an integrated circuit, such as an application specific integrated circuit (ASIC) or a field programmable gate array (FPGA), or an electronic circuit, such as a central processing unit (CPU) or a micro processing unit (MPU).

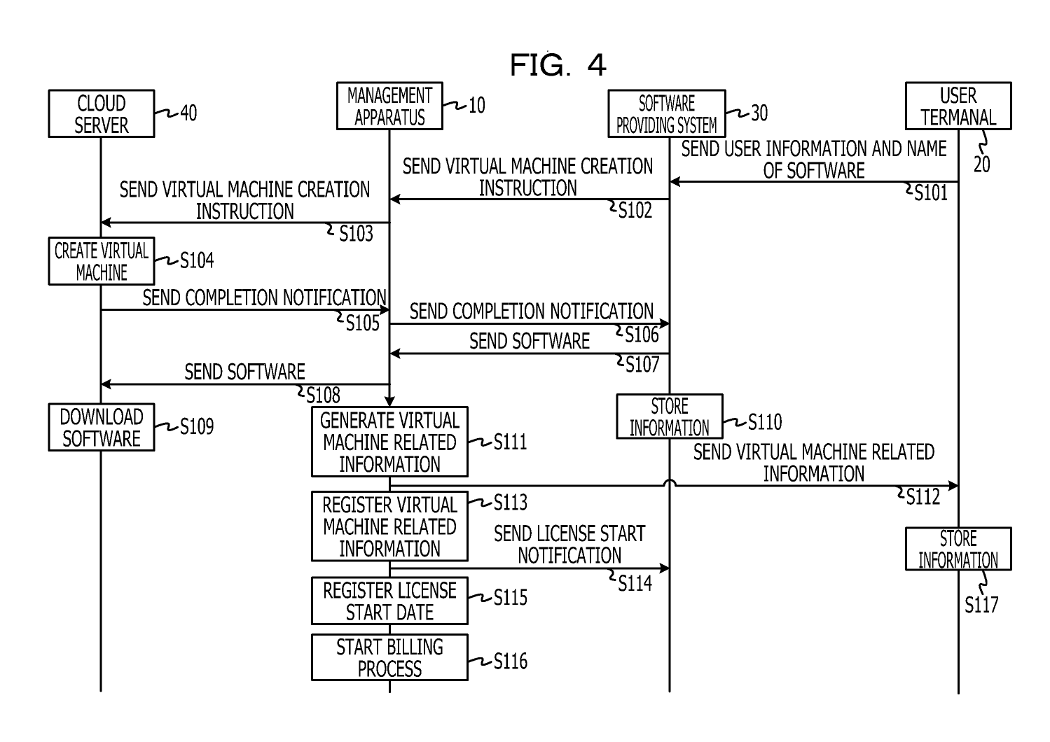

The processing flow of the system 1 according to the present exemplary embodiment is described next. FIG. 4 is a sequence diagram of the sequence of the processes performed by the system according to the present exemplary embodiment.

As illustrated in FIG. 4, in response to a user operation, the user terminal 20 sends the mail address of the user terminal 20 and a the name of the trial software to the software providing system 30. In this way, the user terminal 20 applies for trial of the software (S101). The software providing system 30 sends, to the management apparatus 10, a virtual machine creation instruction including the mail address of the user terminal 20 and the mail address of the server that provides the software (S102). Subsequently, the management apparatus 10 generates the identifier of the VM 40a and sends a virtual machine creation instruction including the generated identifier to the cloud server 40 (S103).

The cloud server 40 creates a VM on the basis of the virtual machine creation instruction sent from the management apparatus 10 (S104). After the VM is created, the cloud server 40 sends a completion notification including the identifier of the created identifier to the management apparatus 10 (S105). Subsequently, the management apparatus 10 sends the received completion notification to the software providing system 30 (S106).

The software providing system 30 sends, to the management apparatus 10, the identifier of the VM included in the completion notification, the license period of the software, and the software having the credit card number of the software vendor attached thereto (S107). The management apparatus 10 sends the received software to the VM 40a indicated by the identifier attached to the software so that the VM 40a downloads the software (S108). The VM 40a created by the cloud server 40 downloads the received software (S109).

The software providing system 30 stores, for example, the identifier of the VM, the name of the software to be executed by the VM, the mail address of the user terminal 20, and the license period of the software in the storage unit of the software providing system 30 (S110).

The management apparatus 10 generates the virtual machine related information (S111). Thereafter, the management apparatus 10 sends the generated virtual machine related information to the user terminal 20 (S112). Subsequently, the management apparatus 10 registers the generated virtual machine related information in a new record of the DB 14a (S113).

Thereafter, the management apparatus 10 sends, to the software providing system 30, a license start notification indicating that the license of the software has been issued (S114). Subsequently, the management apparatus 10 registers the current date in the “start-day” field of the new record as the license start date indicating the date on which the license of the software is issued (S115).

The management apparatus 10 refers to the DB 14a and starts a billing process to charge a fee for the usage of the VM 40a to the billing address registered in the “billing” field (S116).

In addition, the user terminal 20 stores the received virtual machine related information in the storage unit (S117).

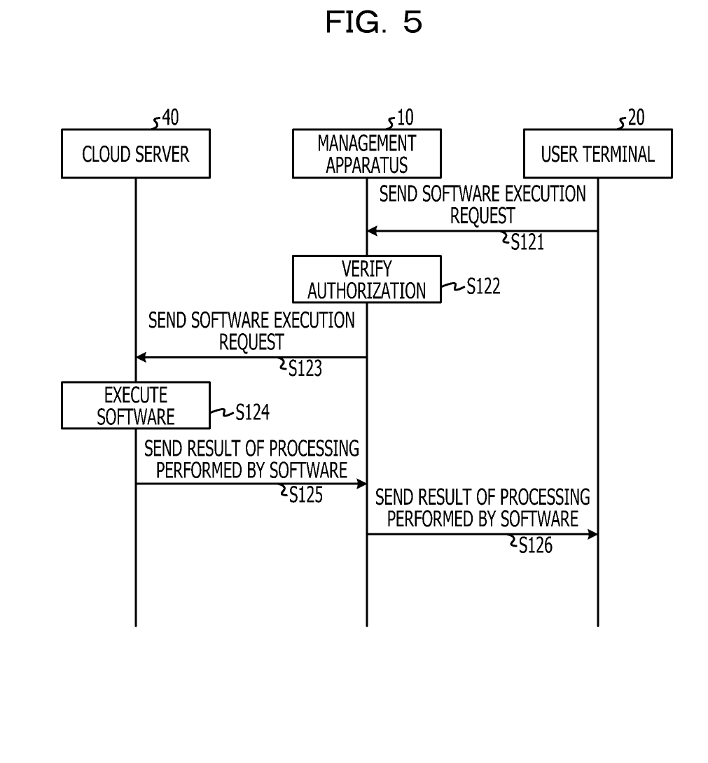

The flow of the processing performed by the system 1 according to the present exemplary embodiment when the user has authorization to use the software is described next. FIG. 5 is a sequence diagram of the system according to the present exemplary embodiment.

As illustrated in FIG. 5, the user terminal 20 sends, to the management apparatus 10, a software execution request including the identifier of the VM 40a that executes the software and the mail address of the user terminal 20 (S121).

The management apparatus 10 searches the DB 14a for the record having the “vmname” field containing the identifier of the VM 40a included in the execution request and the “username” field containing the mail address included in the execution request. In this way, the management apparatus 10 determines whether the user of the user terminal 20 which the management apparatus 10 can communicate with using the mail address registered in the “username” field has authorization to use the software (S122).

If a matched record is found, the management apparatus 10 sends a software execution request to the VM 40a indicated by the included identifier (S123). The VM 40a of the cloud server 40 executes the software (S124). Thereafter, the cloud server 40 sends, to the management apparatus 10, the result of processing performed by the software executed by the VM 40a (S125). The management apparatus 10 sends, to the user terminal 20, the result of processing performed by the software, that is, the result sent from the VM 40a (S126).

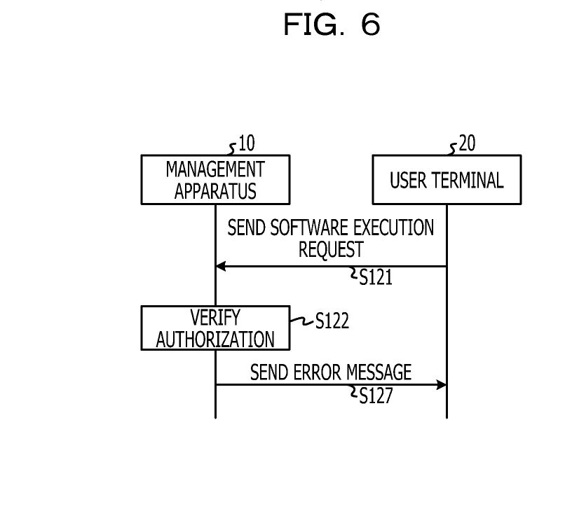

The flow of the processing performed by the system 1 according to the present exemplary embodiment when the user does not have authorization to use the software is described next. FIG. 6 is a sequence diagram of the sequence of the processes performed by the system according to the present exemplary embodiment.

The processes performed in steps S121 and S122 illustrated in FIG. 6 are the same as the processes performed in steps S121 and S122 illustrated in FIG. 5, respectively. Accordingly, descriptions of the processes are not repeated. As illustrated in FIG. 6, if a matched record is not found in the search, an error message indicating that the software and the VM 40a are not available to the user terminal 20 (S127).

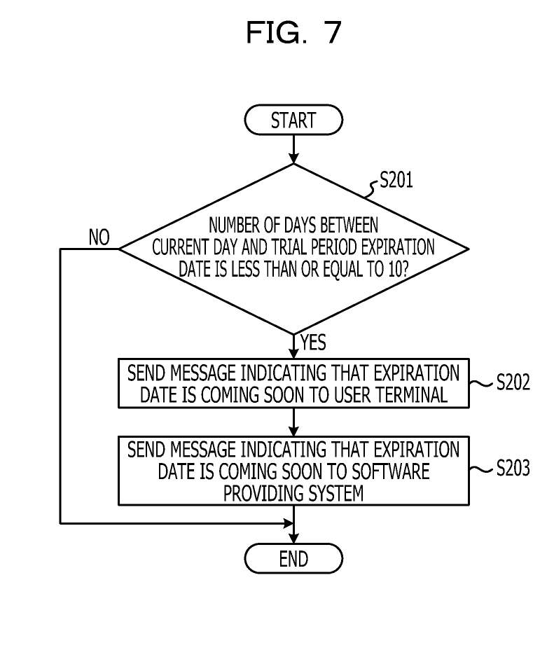

The flow of the processing performed by the management apparatus 10 according to the present exemplary embodiment is described next. FIG. 7 is a flowchart of the procedure of a first management process according to the present exemplary embodiment. The first management process is performed by the management apparatus 10 at, for example, predetermined time intervals.

As illustrated in FIG. 7, the management apparatus 10 refers to the DB 14a and computes the trial period expiration date of the software for each of all of the records. Thereafter, the management apparatus 10 determines whether the number of days between the current date and the expiration date of the trial period is no more than a predetermined number of days (e.g., 10 days) for each of all of the records (S201). If the number of days between the current date and the expiration date of the trial period is no more than the predetermined number of days (Yes in S201), the management apparatus 10 sends a message indicating that the expiration date is coming soon to the user terminal for which the number of days between the current date and the expiration date of the trial period is no more than the predetermined number of days (S202). Thereafter, the management apparatus 10 sends a message indicating that the expiration date is coming soon to the software providing system 30 (S203). Subsequently, the management apparatus 10 completes its processing. However, if the number of days between the current date and the expiration date of the trial period is more than the predetermined number of days (No in S201), the management apparatus 10 immediately completes its processing.

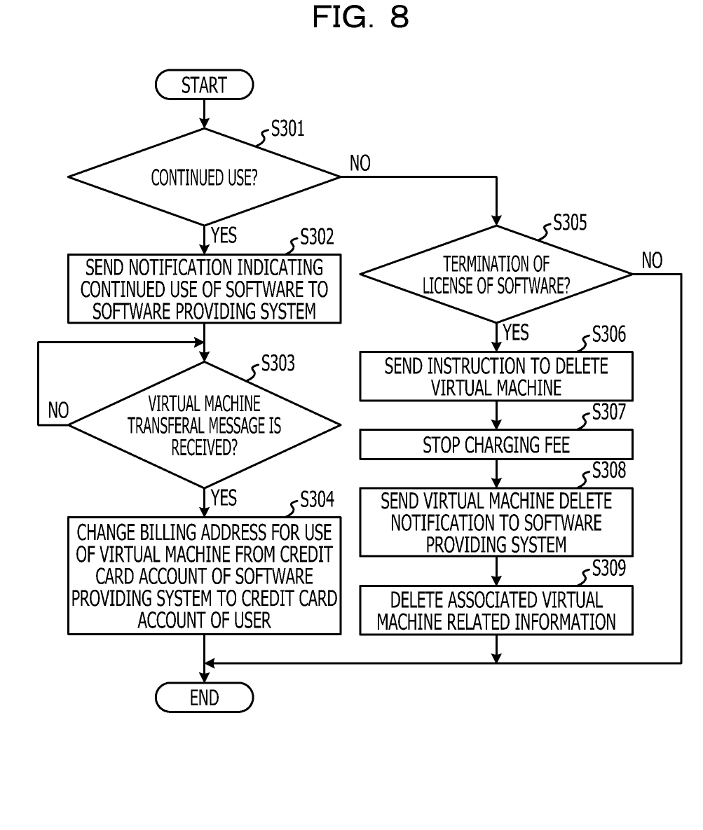

FIG. 8 is a flowchart of the procedure of a second management process according to the present exemplary embodiment. The second management process is performed by the management apparatus 10, for example, each time the management apparatus 10 receives a notification from the user terminal 20. As illustrated in FIG. 8, the management apparatus 10 determines whether the received notification indicates that the license of the software is extended (S301). If the received notification indicates that the license of the software is extended (Yes in S301), the management apparatus 10 sends a notification indicating that the license of the software is extended to the software providing system 30 (S302). Thereafter, the management apparatus 10 determines whether a virtual machine transferal message indicating that the VM is transferred is received from the software providing system 30 (S303). If the virtual machine transferal message is not received (No in S303), the management apparatus 10 repeatedly makes the determination in S303. However, if the virtual machine transferal message is received (Yes in S303), the management apparatus 10 searches the DB 14a for a record including an identifier that is the same as the identifier included in the virtual machine transferal message. Thereafter, the second setting unit 15d sets the credit card number of the user included in the virtual machine transferal message in the “billing” field of the found record (S304). Thereafter, the second management process is completed.

However, if the received notification does not indicate that the license of the software is extended (No in S301), the management apparatus 10 determines whether the received notification indicates termination of the license of the software (S305). If the received notification indicates termination of the license of the software (Yes in S305), the management apparatus 10 sends, to the cloud server 40, an instruction to delete the VM indicated by the identifier included in the notification indicating termination of the license of the software (S306). Thereafter, the management apparatus 10 stop charging a fee for the use of the software (S307). The management apparatus 10 sends, to the software providing system 30, a virtual machine delete notification indicating that the VM has been deleted and including the identifier of the deleted VM (S308). Subsequently, the management apparatus 10 searches the DB 14a for a record having the “vmname” field containing the identifier of the deleted VM and deletes the found record (S309). Thereafter, the second management process is completed. However, if the received notification does not indicate termination of the license of the software (No in S305), the second management process is immediately completed.

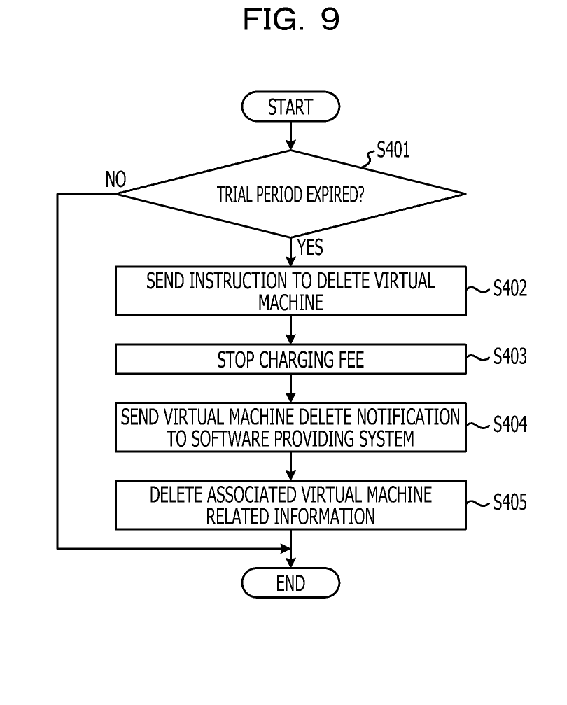

FIG. 9 is a flowchart of the procedure of a third management process according to the present exemplary embodiment. The third management process is performed by the management apparatus 10 at, for example, predetermined time intervals. As illustrated in FIG. 9, the management apparatus 10 refers to the DB 14a and computes the trial period expiration date of the software for each of all of the records. Thereafter, the management apparatus 10 determines whether the current date exceeds the trial period expiration date (S401). If the current date exceeds the trial period expiration date (Yes in S401), the management apparatus 10 sends, to the cloud server 40, an instruction to delete the VM indicated by the identifier registered in the “vmname” field of the record having a trial period expiration date that has already expired (S402). Subsequently, the management apparatus 10 stops charging a fee for the use of the VM (S403). Thereafter, the management apparatus 10 sends, to the software providing system 30, a virtual machine delete message indicating that a VM has been deleted and including the identifier of the deleted VM (S404). Subsequently, the management apparatus 10 searches the DB 14a for a record including the “vmname” field containing the identifier of the deleted VM and deletes the found record (S405). Thereafter, the third management process is completed.

As described above, according to the present exemplary embodiment, upon receipt of an instruction related to creation of a VM from the software providing system 30, the management apparatus 10 performs control so that a VM is created. In addition, upon receipt of the software to be executed by the VM, that is, upon receipt of a message specifying the software to be executed by the VM, the management apparatus 10 performs control so that the software can be executed by a created VM. Thereafter, according to the present exemplary embodiment, the management apparatus 10 performs control so that the software is executed by the VM in response to an execution instruction of the software sent from the user terminal 20 and, subsequently, the result of processing performed by the software is sent to the user terminal 20. Thereafter, according to the present exemplary embodiment, after the VM is created, the management apparatus 10 sets the billing address for the use of the VM to the billing address corresponding to the software providing system 30. Subsequently, according to the present exemplary embodiment, the management apparatus 10 changes the billing address for the use of the VM from the billing address corresponding to the software providing system 30 to the billing address corresponding to the user terminal 20. In this way, according to the present exemplary embodiment, in the case where the license of the software is extended, the management apparatus 10 does not use a license key. Thus, according to the present exemplary embodiment, the management apparatus 10 allows the user to extend the license period of the software in a simplified manner.

In addition, since a fee is charged to the owner of the VM, the fee is charged to the user having authorization for the use of the VM. That is, according to the present exemplary embodiment, when a VM is created, the management apparatus 10 registers the credit card number corresponding to the software providing system 30 in the “billing” field related to the authorization for the use of the VM. Thereafter, according to the present exemplary embodiment, the management apparatus 10 registers the credit card number corresponding to the user terminal 20 in the “billing” field related to the authorization for the use of the VM. In this way, according to the present exemplary embodiment, in the case where the license of the software is extended, the management apparatus 10 does not use a license key. Thus, according to the present exemplary embodiment, the management apparatus 10 allows the user to extend the license period of the software in a simplified manner.

In addition, according to the present exemplary embodiment, the management apparatus 10 does not force the user to generate an environment for the trial use of the software, such as a server environment. Thus, according to the present exemplary embodiment, the management apparatus 10 can provide an environment in which the user can start trial of the software in a simplified manner. For example, according to the present exemplary embodiment, even when the trial software is executed under a large-scale server operation system (OS), the user does not have to build such a large-scale system. In this manner, an environment in which the user can simply make trial of the software can be provided.

Furthermore, according to the present exemplary embodiment, the management apparatus 10, in the case where the license of the software is extended, the management apparatus 10 does not rebuild the environment, such as a server in which the software is executed. Therefore, according to the present exemplary embodiment, the management apparatus 10 allows the user to extend the license period of the software in a simplified manner.

Still furthermore, according to the present exemplary embodiment, in the case where the license of the software is extended, the management apparatus 10 continuously provides the environment in which the software has been executed for trial to the user. Thus, according to the present exemplary embodiment, the management apparatus 10 allows the user to extend the license period of the software in a simplified manner.

Yet still furthermore, according to the present exemplary embodiment, the management apparatus 10 acquires, from the cloud server 40, the operating conditions of the VM running in the cloud server 40 at predetermined time intervals and sends the acquired operating conditions to the software providing system 30. Thus, according to the present exemplary embodiment, the management apparatus 10 can notify the software providing system 30 of the operating conditions of the VM.

Yet still furthermore, according to the present exemplary embodiment, the management apparatus 10 does not install an application that manages the trial period in the VM that executes the software. Thus, according to the present exemplary embodiment, the management apparatus 10 can manage an expiration date of the trial period even when a VM that does not allow installation of an application therein is employed.

While the present disclosure has been described with reference to the exemplary embodiments of an apparatus, the present disclosure can be realized in a variety of forms other than the above-described exemplary embodiments. Other exemplary embodiments of the present disclosure are described below.

A modification of the above-described exemplary embodiment is described first. While the above exemplary embodiment has been described with reference to the process in which when a VM is created, a billing address corresponding to the software providing system 30 is set, the process performed by the apparatus of the present disclosure is not limited thereto. The apparatus according to the present disclosure can set the credit card account of the user as the billing address when a VM is created. In such a case, in response to a user operation, the user terminal 20 sends, to the software providing system 30, the mail address of the user terminal 20, the name of the trial software, and the credit card number of the user in order to apply for trial of the software. Thereafter, the software providing system 30 sends, to the management apparatus 10, a virtual machine creation instruction including the mail address of the user terminal 20, the mail address of a server that provides the software, and the credit card number of the user. In addition, the first setting unit 15c of the management apparatus 10 generates the virtual machine related information including the credit card number of the user. Subsequently, the first setting unit 15c of the management apparatus 10 registers the generated virtual machine related information in a new record of the DB 14a.

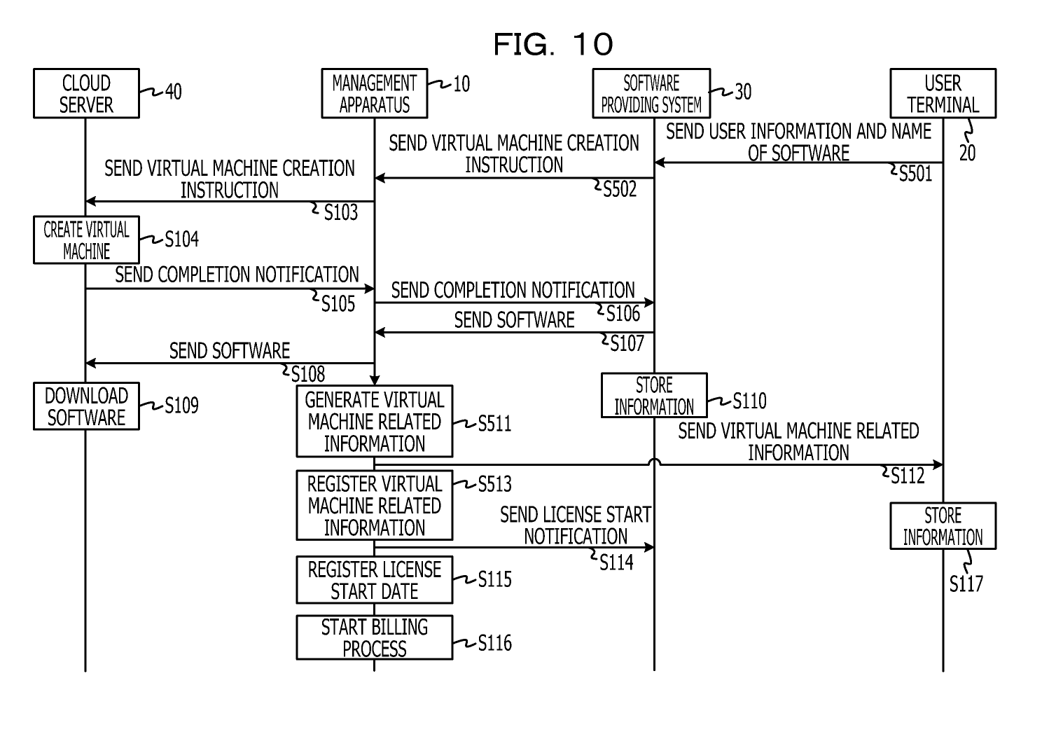

FIG. 10 is a sequence diagram of the sequence of the processes performed by the system according to the modification. The processes performed in steps S103 to S110, S112, and steps S114 to S116 illustrated in FIG. 10 are the same as those performed in steps S103 to S110, S112, and steps S114 to S116 illustrated in FIG. 4, respectively. Accordingly, descriptions of the processes are not repeated. As illustrated in FIG. 10, in response to a user operation, the user terminal 20 sends the mail address of the user terminal 20, the name of the trial software, and the credit card number of the user to the software providing system 30 in order to apply for trial of the software (S501). Thereafter, the software providing system 30 sends, to the management apparatus 10, a virtual machine creation instruction including the mail address of the user terminal 20, the mail address of a server that provides the software, and the credit card number of the user (S502). In addition, the management apparatus 10 generates virtual machine related information including the credit card number of the user (S511). Thereafter, the management apparatus 10 registers the generated virtual machine related information in a new record of the DB 14a (S513).

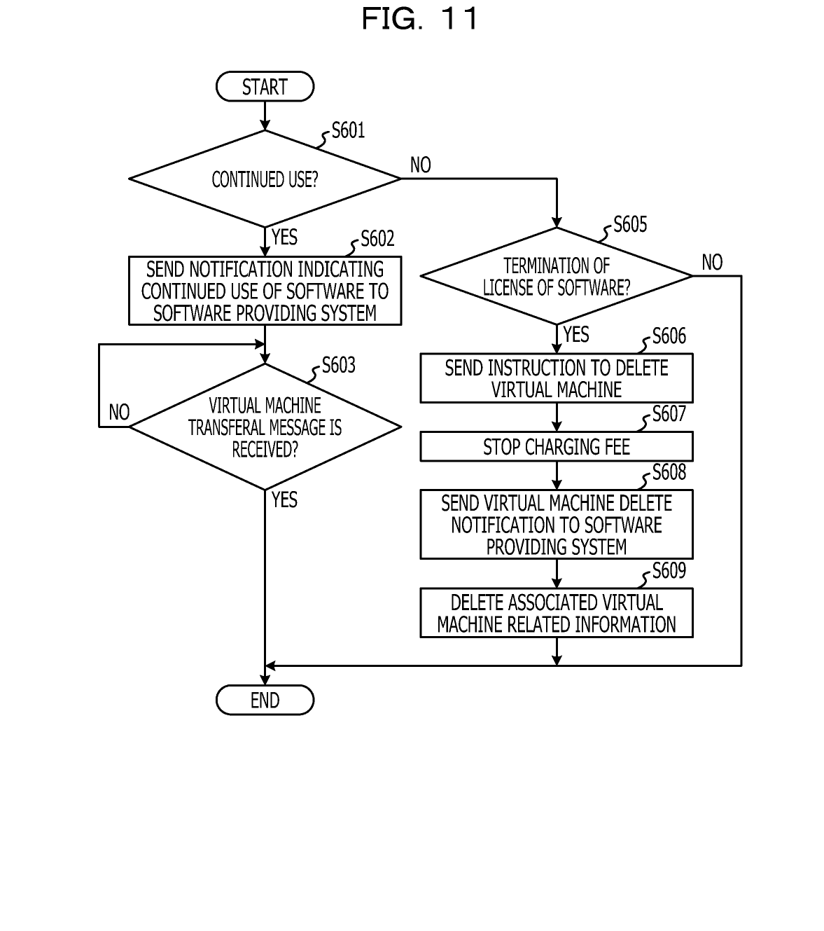

FIG. 11 is a flowchart of the procedure of a second management process according to the modification. The flowchart illustrated in FIG. 11 is the same as a flowchart generated by removing S304 from the flowchart of the second management illustrated in FIG. 8. The processes performed in steps S601 to S603 and steps S605 to S609 illustrated in FIG. 11 are the same as those performed in steps S301 to S303 and steps S305 to S309 illustrated in FIG. 8, respectively. Accordingly, descriptions of the processes are not repeated.

As described above, according to the present modification, when a VM is created, the billing address related to the use of the VM is set to the billing address corresponding to the user terminal 20. Subsequently, according to the present modification, in the case where the license of the software is extended, the billing address remains unchanged. In the case where the license of the software is terminated, the billing address is deleted. In this way, according to the present modification, in the case where the license of the software is extended, the license key is not used. Thus, according to the present modification, the license period of the software can be extended in a simplified manner.

In addition, according to the present modification, when a VM is created, the credit card number corresponding to the user terminal 20 is registered in the “billing” field indicating the authorization information for use of a VM. Thereafter, according to the present modification, in the case where the license of the software is extended, the information in the “billing” field remains unchanged. However, in the case where the license of the software is terminated, the unregistering unit 15e according to the present modification unregisters the correspondence between the credit card number of the user terminal 20 and the information in the “billing” field indicating the authorization information for the use of the VM. In this way, in the case where the license of the software is extended, the management apparatus 10 according to the present modification does not use a license key. Thus, according to the management apparatus 10 of the present modification, the license period of the software can be extended in a simplified manner.

While the exemplary embodiment has been described with reference to the apparatus that performs control so that upon receipt of the software to be executed by a VM, the software is executable by a created VM, the control performed by the apparatus of the present disclosure is not limited thereto. For example, the software providing system 30 may send a received completion notification to the user terminal 20. Upon receipt of the completion notification, the user terminal 20 may send a message indicating the software to be executed by a VM to the management apparatus 10. In such a case, upon receipt of the message indicating the software to be executed by a VM, the management apparatus 10 can request the software providing system 30 to send the software indicated by the received message. Upon receipt of such a request, the software providing system 30 sends the requested software to the management apparatus 10. The management apparatus 10 performs control so that the received software is executable in a generated VM. As described above, upon receipt of a message indicating the software to be executed by a VM, the management apparatus 10 can perform control so that the software is executable by the generated VM.

While the exemplary embodiment has been described with reference to the apparatus functioning as a server, any physical or virtual apparatus, such as a network apparatus or a storage apparatus, can be employed.

Among the processes described in the exemplary embodiments, all or some of the processes described as automatically performed processes can be manually performed. In addition, all or some of the processes described as manually performed processes can be automatically performed using a widely used technique.

The process performed in each of the steps described in the above embodiments may be separated into small processes. In addition, the processes performed in the above-described steps may be appropriately combined together in accordance with a variety of load conditions or use conditions. In addition, any one or some of the steps may be removed.

Furthermore, the sequence of the processes performed in the steps described in the above-described embodiments may be changed in accordance with a variety of load conditions or use conditions.

Still furthermore, the components of the apparatuses illustrated in the drawings are functionally conceptual, and can be changed to a different physical configuration. That is, distribution and integration of the components of the apparatuses are not limited to those illustrated in the drawings, and all or some of the components can be functionally or physically distributed or integrated in an optimal manner in accordance with a variety of load conditions or use conditions.

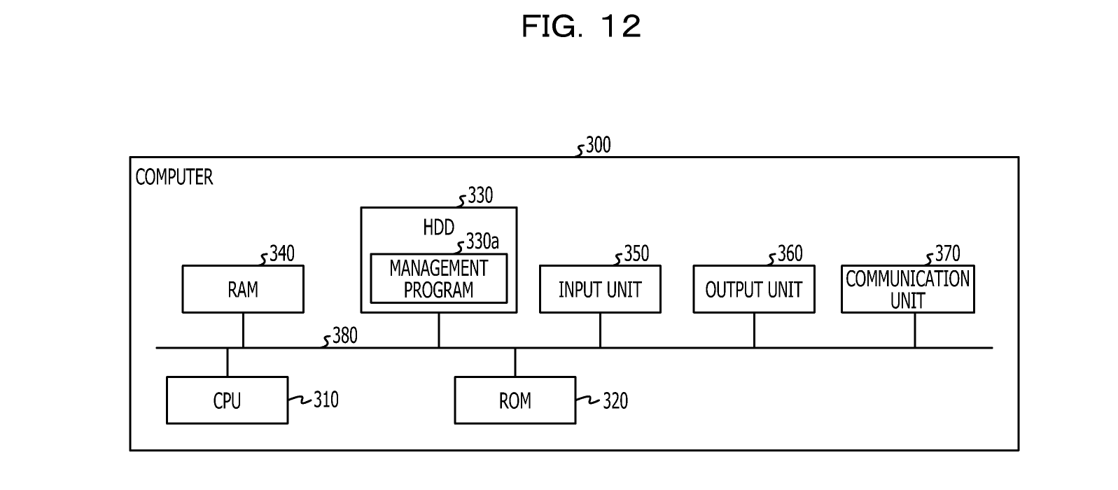

Yet still furthermore, the processes performed by the management apparatus 10 according to the above-described exemplary embodiment may be realized by a computer system (e.g., a personal computer or a workstation) that executes a predetermined program. Accordingly, an example of a computer that executes a management program having the function of the management apparatus 10 according to the above-described exemplary embodiment is described below with reference to FIG. 12. FIG. 12 illustrates a computer that executes the management program.

As illustrated in FIG. 12, a computer 300 includes a CPU 310, a ROM 320, a hard disk drive (HDD) 330, and a RAM 340. In addition, the computer 300 includes an input unit 350, an output unit 360, and a communication unit 370. The CPU 310, the ROM 320, the HDD 330, the RAM 340, the input unit 350, the output unit 360, and the communication unit 370 are connected to one another via a bus 380. The CPU 310 is an example of a processor which reads out and executes the management program from the R0M320. The processor is a hardware to carry out operations based on at least one program (such as the management program) and control other hardware, such as the CPU 310, a GPU (Graphics Processing Unit), FPU (Floating point number Processing Unit) and DSP (Digital signal Processor).

The input unit 350 includes a keyboard and a mouse. The input unit 350 corresponds to the input unit 11. An example of the output unit 360 is a liquid crystal display device. The output unit 360 corresponds to the output unit 12. The communication unit 370 serves as an interface for communication. The communication unit 370 corresponds to the communication unit 13.

The ROM 320 stores a basic program, such as an OS. The HDD 330 prestores a management program 330a. The management program 330a provides the functions of the first control unit 15a, the second control unit 15b, the first setting unit 15c, the second setting unit 15d, and the unregistering unit 15e of the above-described exemplary embodiment. Note that the management program 330a may be appropriately separated into small programs. In addition, the HDD 330 stores a DB. The DB corresponds to the DB 14a.

The CPU 310 reads the management program 330a from the HDD 330 and executes the management program 330a.

Thereafter, the CPU 310 reads the DB and loads the DB in the RAM 340. In addition, the CPU 310 uses the DB loaded into the RAM 340 and executes the management program 330a. All of the data items to be loaded into the RAM 340 are not necessarily loaded at the same time. Only the data items used for the processing can be loaded into the RAM 340 at that time.

Note that it is unnecessary to store the above-described management program 330a in the HDD 330 at all times.

For example, the management program 330a may be stored in a “removable physical medium” mounted in the computer 300. Examples of the removable physical medium include a flexible disk (FD), a compact disc read only memory (CD-ROM), a digital versatile disk (DVD), a magnetooptical disk, and an IC card. The computer 300 may read the management program 330a from the removable physical medium and execute the management program 330a.

Alternatively, the management program 330a may be stored in, for example, “another computer (or server)” connected to the computer 300 via a public line, the Internet, a local area network (LAN), or a wide area network (WAN). The computer 300 may read the management program 330a from another computer (or server) and execute the management program 330a.

According to the above-described exemplary embodiments, the management apparatus, the management program, and the management method allow a user to extend the license period of software in a simplified manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management method comprising:
setting, by a processor, billing address for usage fees of a virtual machine, deployed based on a deploy instruction from a first account, to a second account from which execution instruction for software, which runs on the virtual machine, is issued.

2. The management method according to claim 1, wherein the procedure further comprises:
controlling to start billing to the second account in response to notice from the first account; and
billing the usage fees to the first account until receiving the notice.

3. The management method according to claim 2, wherein the billing bills the usage fees to the first account from time the virtual machine is deployed until the receiving of the notice.

4. The management method according to claim 1, wherein the procedure further comprises:
canceling the set billing address, in response to termination instruction for the virtual machine from the second account.

5. The management method according to claim 1, wherein
the software is installed to the virtual machine based on an install instruction from the first account.

6. A computer-readable recording medium storing a management program that causes a computer to execute a procedure, the procedure comprising:
setting billing address for usage fees of a virtual machine, deployed based on a deploy instruction from a first account, to a second account from which execution instruction for software, which runs on the virtual machine, is issued.

7. The recording medium according to claim 6, wherein the procedure further comprises:
controlling to start billing to the second account in response to notice from the first account; and
billing the usage fees to the first account until receiving the notice.

8. The recording medium according to claim 7, wherein the billing bills the usage fees to the first account from time the virtual machine is deployed until the receiving of the notice.

9. The recording medium according to claim 6, wherein the procedure further comprises:
canceling the set billing address, in response to termination instruction for the virtual machine from the second account.

10. The recording medium according to claim 6, wherein
the software is installed to the virtual machine based on an install instruction from the first account.

11. A management apparatus comprising:
a memory; and
a processor that executes a procedure, the procedure including:
setting billing address for usage fees of a virtual machine, deployed based on a deploy instruction from a first account, to a second account from which execution instruction for software, which runs on the virtual machine, is issued; and
storing the set billing address in the memory.

12. The management apparatus according to claim 11, wherein the procedure further comprises:
controlling to start billing to the second account in response to notice from the first account; and
billing the usage fees to the first account until receiving the notice.

13. The management apparatus according to claim 12, wherein the billing bills the usage fees to the first account from time the virtual machine is deployed until the receiving of the notice.

14. The management apparatus according to claim 11, wherein the procedure further comprises:
canceling the set billing address, in response to termination instruction for the virtual machine from the second account;

15. The management apparatus according to claim 11, wherein
the software is installed to the virtual machine based on an install instruction from the first account.
